(19) United States
(12) Patent Application Publication
(10) Pub. No.: US 2015/0290736 A1
(43) Pub. Date: Oct. 15, 2015

(54) WELDING WIRE FEEDING DEVICE AND METHOD

(71) Applicants: Jing Zhang, Shanghai (CN); Pei-Chung Wang, Troy, MI (US); David Yang, Shanghai (CN)

(72) Inventors: Jing Zhang, Shanghai (CN); Pei-Chung Wang, Troy, MI (US); David Yang, Shanghai (CN)

(73) Assignee: GM Global Technology Operation LLC, Detroit, MI (US)

(21) Appl. No.: 14/425,265

(22) PCT Filed: Sep. 5, 2012
(86) PCT No.: PCT/CN2012/080997

§ 371 Date: Jun. 22, 2015

(51) Int. Cl. B23K 9/133; B23K 9/10; B23K 26/14; B23K 3/06

(52) U.S. Cl. CPC B23K 9/133; B23K 3/063; B23K 9/1093; B23K 26/1476

(57) ABSTRACT

Disclosed are wire feeding devices having a wire feeding pipe and a feed unit that pushes a wire through the wire feeding pipe. Either the wire feeding pipe comprises a two- way shape-memory alloy or the wire feeding pipe has an attached, over-lapping, or inserted extension segment extending beyond a distal end of the wire feeding pipe, the extension section comprising a two-way shape-memory alloy. The two-way shape-memory alloy has a trained shape in a martensite phase having a passageway for a wire and a trained shape in an austenite phase having a passageway for a wire that is narrower than the martensite phase passageway. When heated to the austenite phase of the two-way shape-memory alloy, the narrower passageway applies pressure to straighten a bend in the wire.

### FIELD OF THE INVENTION

The present invention relates to welding and joining methods and articles used in such methods. In another aspect, the invention relates to processes involving alignment of wires and such.

### INTRODUCTION TO THE DISCLOSURE

This section provides information helpful in understanding the invention but that is not necessarily prior art.

Gas metal arc welding (GMAW), also called metal inert gas (MIG) welding, is an arc welding process using a continuous, consumable weld or filler wire as electrode. In gas metal arc welding, the consumable wire electrode passes through a welding gun or torch and out a torch contact tip, which is made of a conducting metal like copper alloys. Electric potential applied between the contact tip and the metal work piece to be welded results in a current in the wire which supports an arc between the wire end and a metal work piece. The arc is shielded from the atmosphere by a flow of a gas or a gas mixture, often an inert gas mixture, with metal transferred to the work piece through the arc from the consumable wire electrode. Laser brazing also feeds a filler wire to a welding site, where it is melted by direct laser irradiation. The drops of molten wire bridge a joint between two work pieces.

Bent wires and wire-to-workpiece misalignment are common occurrences during arc welding, laser brazing, soldering, arc brazing, and other joining processes or thermal fusion processes that use filler wire. The misalignment of the wire with respect to the weld seam can cause an unstable welding and joining process and result in poor weld quality. Therefore, manual adjustments are often needed to straighten the bent wire, delaying production. Bent wires and wire-to-workpiece misalignment can be a problem in other processes as well, for example when wire is threaded through a hole.

### SUMMARY OF THE DISCLOSURE

This section provides a general summary rather than a comprehensive disclosure of the full scope of the invention or all of its features.

Disclosed is a wire feeding device that can be heat-activated to straighten wire passing through the feeding device. The wire feeding device has a feed unit that pushes a wire through a wire feeding pipe. Either the wire feeding pipe comprises a two-way shape-memory alloy, which may be at least at a distal end where the wire leaves the pipe, or the wire feeding pipe has an attached, overlapping, or inserted extension section comprising a two-way shape-memory alloy extending beyond a distal end of the wire feeding pipe, the extension section having an inlet and an outlet for the wire and the extension section comprising a two-way shape-memory alloy. The two-way shape-memory alloy of the wire feeding pipe distal end or extension section when heated above a martensite to austenite phase transition temperature assumes a trained shape of a narrower diameter passageway for the wire that presses on bends in the wire to straighten the wire. When the wire feeding device is a part of a welding apparatus, the extension segment may bridge between the wire feeder pipe and a welding torch or gun.

Further disclosed is a process of feeding wire with the wire feeding device through the wire feeding pipe and optional extension segment; heating the wire feeding pipe or extension segment to a temperature above the shape-memory alloy martensite to austenite phase transition temperature, causing the wire feeding pipe or extension segment comprising the two-way shape-memory alloy to assume a trained shape having a narrower opening for the wire to pass through; wherein the narrowing of the opening applies pressure to straighten a bend in the wire. In various embodiments the process may be a thermal joining process in which a wire, after leaving the wire feeding device in its straightened form, is used as filler in joining two work pieces. The joining process may be a gas metal arc welding process, in which the straightening of the wire aids in positioning the wire in the joining process. In other embodiments, the process may include a further step of aligning or positioning the straightened wire. “Straightened” and “straightening” refer to the wire being made straighter relative to the original, bent portion of the wire; the wire need not be literally straight after being subjected to the disclosed straightening process, but the angle of the bend in the wire is closer to 0° with respect to the feeding direction of the wire compared to before being acted on by the wire feeding pipe or extension segment comprising the two-way shape-memory alloy.

In addition to causing the wire feeding pipe or extension segment to assume its austenite phase trained shape, heat from the heated wire feeding pipe or extension segment preheats the wire to some extent, which can serve to improve the process quality in a thermal joining process.

“A,” “an,” “the,” “at least one,” and “one or more” are used interchangeably to indicate that at least one of the item is present; a plurality of such items may be present unless the context clearly indicates otherwise. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range.

The terms “comprises,” “comprising,” “including,” and “having,” are inclusive and therefore specify the presence of stated items, but do not preclude the presence of other items. As used in this specification, the term “or” includes one or any and all combinations of two or more of the associated listed items. When the terms first, second, third, etc. are used to differentiate various items from each other, these designations are merely for convenience and do not limit the items.

Further areas of applicability will become apparent from the detailed description and illustrative specific examples following.

### BRIEF DESCRIPTION OF THE DRAWINGS

The drawings illustrate selected embodiments but not all possible implementations or variations described in this disclosure.

FIG. 1 schematically illustrates a portion of a wire feeding pipe containing a wire;

FIG. 2 illustrates a change in an area of the wire feeding pipe of FIG. 1 when heated above its martensite to austenite transition temperature;

FIG. 3 illustrates an alternative embodiment of a wire feeding device in which a wire feeding pipe has an extension segment at an end;

FIG. 4 illustrates and change in the extension segment when heated above its martensite to austenite transition temperature;

FIG. 5 is a schematic elevation of an embodiment of a GMAW system including a wire feeding pipe; and

FIG. 6 is a cut-away perspective view of a torch nozzle for the GMAW system of FIG. 5.

### DETAILED DESCRIPTION

A detailed description of exemplary, nonlimiting embodiments follows.

The wire feeding device has a wire feeding pipe or extension at a distal end of the wire feeding pipe comprising a two-way shape-memory alloy trained to have a smaller or narrower internal passageway in its austenite phase compared to its internal passageway in its martensite phase. Shape-memory alloys are alloys that demonstrate an ability to return to a previously defined shape and/or size when subjected to an appropriate thermal stimulus. Two-way shape memory alloys are capable of undergoing phase transitions between a lower-temperature martensite phase and a higher temperature austenite phase in which their dimensions or shapes are altered as a function of temperature. Two-way shape memory alloys have a martensite phase trained shape and an austenite phase trained shape. The austenite phase trained shape is a pipe of narrower interior opening (e.g., narrower diameter when the pipe has a circular cross-section) than the diameter of the pipe when the two-way shape memory alloy is in its martensite phase trained pipe shape. The interior opening of the wire feeding pipe in its austenite phase should be just greater in size than that of the wire so that, when pipe narrows when heated to the austenite phase of the two-way smart-material alloy, the pipe wall presses against a bend in the wire inside the pipe to straighten the bend at least partially.

The martensite phase shape and the austenite phase shape may be set during the manufacturing of the wire feeding pipe or extension segment. When the wire feeding pipe or extension segment comprising the two-way shape memory alloy is in the martensite phase and is heated, it begins to change into the austenite phase configuration in which it has a narrower passageway for the wire. The temperature at which this phenomenon starts is often referred to as austenite start temperature (Aₛ). The temperature at which this phenomenon is complete is called the austenite finish temperature (A_{f}). When the wire feeding pipe or extension segment comprising the two-way shape memory alloy is in the austenite phase and is cooled, it begins to change into the martensite phase configuration in which it has a wider diameter, and the temperature at which this phenomenon starts is referred to as the martensite start temperature (Mₛ). The temperature at which austenite finishes transforming to martensite is called the martensite finish temperature (M_{f}). In general, the austenite to martensite transition may be brought about by allowing heat to dissipate to the surrounding air or environment. A suitable thermal activation stimulus is one having a magnitude to cause transformations between the martensite and austenite phases.

An article made of the two-way shape memory alloy change between its trained shape in the martensite phase and its trained shape in the higher temperature austenite phase as its temperature increases The two-way shape memory alloys of the wire feeding pipe or extension segment are trained to have a smaller internal passageway, e.g. a narrower diameter, in the austenite phase. The narrower passageway is selected to apply pressure to a bend or bends in a wire being fed through the pipe or extension segment to straighten a bend in the wire towards being straight, such that the angle of the bend in the wire is closer to 0° with respect to the feeding direction of the wire compared to before being acted on by the wire feeding pipe or extension segment comprising the two-way shape-memory alloy. The wire feeding pipe segment or extension segment may be maintained in its heated, austenite phase with a narrower passageway while wire is being fed through.

Intrinsic and extrinsic two-way shape memory materials are characterized by a shape transition both upon heating from the martensite phase to the austenite phase, as well as an additional shape transition upon cooling from the austenite phase back to the martensite phase. Intrinsic two-way shape memory behavior must be induced in the shape memory material through thermo-mechanical processing. Such procedures include extreme deformation of the material while in the martensite phase, heating-cooling under constraint or load, or surface modification such as laser annealing, polishing, or shot-peening. Once the material has been trained to exhibit the two-way shape memory effect, the shape change between the low and high temperature states is generally reversible and persists through a high number of thermal cycles. In contrast, active materials that exhibit the extrinsic two-way shape memory effects are composite or multi-component materials that combine a shape-memory alloy composition that exhibits a one-way effect with another element that provides a restoring force to recover the original shape of the composite.

The phase transition temperature for the two-way shape-memory alloy can be adjusted by slight changes in the composition of the alloy and through heat treatment. In nickel-titanium shape-memory alloys, for instance, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape-memory alloy vary greatly over the temperature range spanning their transformation, typically providing the system with shape memory effects, super-elastic effects, and high damping capacity.

Suitable shape-memory alloy materials include, without limitation, nickel-titanium based alloys, indium-titanium based alloys, nickel-aluminum based alloys, nickel-gallium based alloys, copper based alloys (e.g., copper-zinc alloys, copper-aluminum alloys, copper-gold, copper-titanium-nickel, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in dimension, elastic modulus, damping capacity, and the like. In typical use, shape-memory alloys exhibit a modulus increase of about 2.5 times and a dimensional change (recovery of pseudo-plastic deformation induced when in the martensitic phase) of up to about 8% (depending on the amount of pre-strain) when heated above their martensite to austenite phase transition temperature.

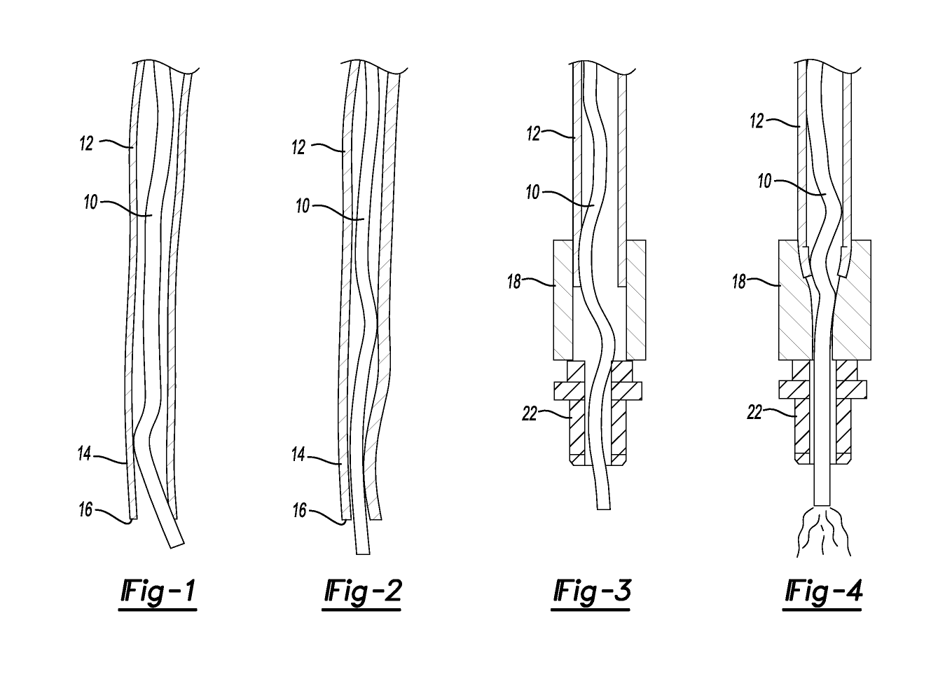

The wire feeding device has a feed unit that pushes a wire through a wire feeding pipe. FIGS. 1 and 2 illustrate a first embodiment of the wire feeding device in which the wire feeding pipe comprises a distal end where the wire leaves the pipe, and at least the distal end comprises a two-way shape-memory alloy. FIG. 1 shows an end portion of wire feeding pipe 12 having a distal end between point 14 and point 16, which is at the end of feeding pipe 12. In FIG. 1, the wire 10 has a bend in the area between point 14 and 16. At least the portion of wire feeding pipe 12 between points 14 and 16 comprises a two-way shape-memory alloy.

The portion of wire feeding pipe 12 between points 14 and 16 in FIG. 1 that comprises a two-way shape-memory alloy is shown in its lower temperature, martensite configuration. FIG. 2 illustrates a change in the area of the wire feeding pipe of FIG. 1 between points 14 and 16 when heated above its martensite to austenite transition. When the shape-memory alloy of the wire feeding pipe is heated to its austenite phase, it assumes a trained shape that has a smaller internal passageway than its internal passageway in its martensite phase. The interior opening of the wire feeding pipe 12 in its austenite phase is just greater in size than that of the wire so that, as the opening narrows in assuming its austenite phase trained shape, the pipe wall presses against the bend in the wire inside the pipe to straighten the bend. The straightened wire can more easily be positioned or aligned.

The length of the wire feeding pipe comprising the two-way shape-memory alloy can vary. The wire feeding pipe may comprise the two-way shape-memory alloy along its entire length or only along a part of its length. In a process of using the wire feeding pipe to provide a straightened wire, all or only a part of the length of the wire feeding pipe that comprises the two-way shape-memory alloy may be heated to its austenite phase trained shape having a narrower passageway.

FIGS. 3 and 4 illustrate an alternative embodiment in which the extension 18 comprising a two-way shape-memory alloy is attached to a distal end of the wire feeding pipe 12. The extension 18 comprising the two-way shape-memory alloy is trained to have a trained shape in its austenite phase that has a smaller internal passageway than the internal passageway it has in its martensite phase. FIG. 3 shows the extension 18 bridging between the wire feeding pipe 12 and a gas metal arc welding torch 22. As the welding process is begun, the extension 18 is heated above its martensite to austenite phase transition so that, as shown in FIG. 4, the internal passageway of extension 18 narrows causing the wall of extension 18 to press against and straighten a bend in wire 10. This makes it easier to position or align the end of wire 10 leaving welding torch 22.

Wire delivered continuously in a gas metal arc welding (GMAW) process is used as a consumable wire electrode. An electric arc is formed between the wire acting as electrode and the work piece to be welded. In gas metal arc welding, the consumable electrode is normally positive and the work piece is negative.

FIG. 5 is a schematic elevation of a GMAW system, particularly illustrating a torch, power supply, self-adjusting wire feed unit, and a shielding gas supply tank. The GMAW system has a torch (or welding gun) 21 having a nozzle 22, a power supply 23, a wire feed unit 24 configured to feed a wire 10 to the torch 21, and a shielding gas supply 26. The welding torch 21 may be oriented so as to maintain a consistent torch tip-to-work distance from pre-positioned work pieces 27. The wire feed unit 24 includes a wire reel 28 of wound wire 10. Wire feeding wheels 30, powered by power supply 23, draw the wire 10 from wire reel 28 and push the wire 10 through wire feeding pipe 12 to the welding torch 21.

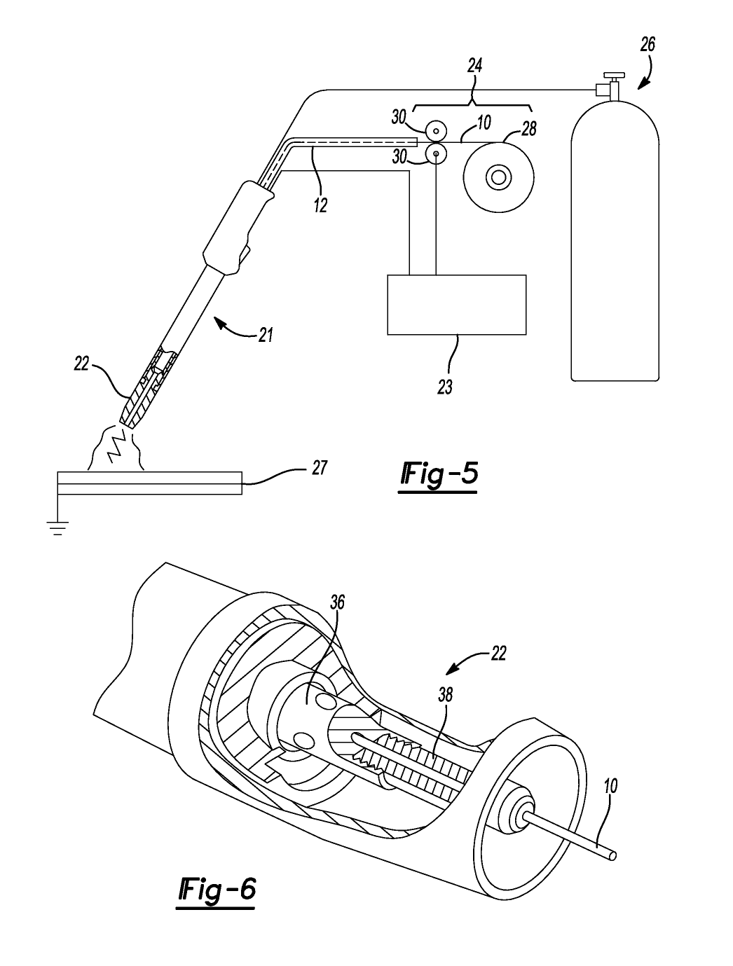

As shown in FIGS. 5 and 6, the welding torch gun nozzle 22 includes an electrically energized contact tip 38 that is axially aligned inside the gun nozzle 22 and configured to charge by contacting the wire 10. Welding power to form the arc is supplied by power supply 23 connected between the welding torch 21 and the work piece 27. The welding torch 21 transfers power to the wire 10, which acts as a consumable electrode, through the contact tip 38. Contact tip 38 makes electrical contact with the wire 10 through a contact surface. The contact surface may extend the length of the contact tip 38 or may extend over just a portion of the length of the contact tip 38. The applied voltage between the charged wire 10, acting as electrode, and work piece 27 produces an intermediate electric arc.

The work piece includes a joint to be welded. During the welding process, the wire 10 is melted by heat produced by its internal resistance and heat transferred from the arc. Molten droplets from the wire are transferred to the work piece 27. The drops of molten wire carried across the arc gap to the work piece 27 form a weld pool on work piece 27, which form a weld bead as the metal solidifies. The mode of metal transfer is dependent upon the operating parameters such as welding current, voltage, wire size, wire speed, electrode extension and the protective gas shielding composition. The known modes of metal transfer include short circuit, globular transfer, axial spray transfer, pulse spray transfer and rotating arc spray transfer. In an embodiment, a substantially constant arc voltage is maintained between the wire electrode and the work piece. In another embodiment, the voltage between the electrode and the work piece may be pulsed. In an embodiment, the arc voltage is greater than 15 V. In other embodiments, the arc voltage is between about 15V and about 50V or between about 15V and about 40 V. The welding current may be from about 50 amperes up to about 600 amperes or from about 50 amperes up to about 500 amperes. The heat of the arc may also melt a portion of the work piece, contributing to formation of a weld pool. A substantially uniform arc length may be maintained between the melting end of the wire electrode and the weld pool by feeding the electrode into the arc as fast as it melts. The welding current may be adapted to the rate as which the wire 10 is fed through the welding gun 21.

Shielding gas from gas supply 26 is diffused by shielding gas diffuser 36 to protect the welding area from atmospheric gases. The shielding gas forms an arc plasma that shields the arc and molten weld pool. Nonlimiting examples of suitable shielding gases are carbon dioxide, argon, helium, oxygen, hydrogen, and nitrogen; mixtures of these may be used as the shielding gas. The preferred shielding gas composition generally depends upon the metal of the work piece.

The work piece may be, for example, any of steels, cast irons, aluminum alloys, copper alloys, nickel-based alloys, titanium alloys, and cobalt alloys.

The wire feeding device and method have been described in detail in the context of a gas arc metal welding process, but they are useful in many additional applications including other joining processes and other processes in which wire can be delivered through a wire feeding pipe or extension segment for use in the process. Nonlimiting further examples of processes in which wire can pass through a two-way smart-material alloy wire feeding pipe or extension segment to be straightened before use include laser brazing, arc brazing, TIG welding with filler wire, soldering, and other joining processes or thermal processes that use filler wire.

One example of a further thermal process for joining metal is laser welding or laser brazing. A laser may be employed to generate light energy that can be absorbed at a location in materials, producing the heat energy necessary to perform the welding operation. By using light energy in the visible or infrared portions of the electromagnetic spectrum, energy can be directed from its source to the material to be welded using optics, which can focus and direct the energy with the required amount of precision. After the applied light energy is removed, the molten material solidifies and then begins to slowly cool to the temperature of the surrounding material. Laser welding systems typically consist of a laser source, a beam delivery system, and a workstation. Carbon dioxide (CO₂) and Nd:YAG (neodymium-doped yttrium aluminum garnet) are two laser sources or laser media that may be used for laser welding applications. Both YAG and CO₂ lasers may be used for seam welding and spot welding of both butt joints and lap (overlap) joints. Solid state lasers (which includes Nd:YAG, Nd:Glass and similar lasers), are often employed in low- to medium-power applications, such as those needed to spot weld or beam lead weld integrated circuits to thin film interconnecting circuits on a substrate, and similar applications. In laser welding, a laser beam is applied to a top surface where two metal work pieces to be joined meet at a joint. At the same time, the self-adjusting wire is inserted into the top surface of the joint and melted to form a weld.

Similarly, a process joining two metal work pieces in a lap joint may experience an alignment problem if the end of the welding wire is bent. The wire may again be straightened by being passed through the wire feeding pipe or extension that is heated above its martensite to austenite phase transition temperature to assume a narrower opening so that the wall of the pipe or extension presses the wire to straighten the wire. The straightened wire is then used in joining two work pieces by a lap joint.

The wire feeding device may likewise be used to deliver wire in other welding and joining processes that use wire and in other processes in which alignment is important, including arc brazing, arc welding, soldering, wire-to-wire welding and wire threading in which heat may be used to narrow the passageway of the wire feeding pipe or extension to straighten the wires.

The foregoing description of certain embodiments has been provided for purposes of illustration and detailed description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A wire feeding device comprising a wire feeding pipe and a feed unit that pushes a wire through the wire feeding pipe, wherein the wire feeding pipe comprising a two-way shape-memory alloy, and wherein the two-way shape-memory alloy has a trained shape in a martensite phase having a passageway for a wire and a trained shape in an austenite phase having a passageway for a wire that is narrower than the martensite phase passageway.

2. A wire feeding device according to claim 1, wherein the two-way shape-memory alloy of the wire feeding pipe is located at least at a distal end of the wire feeding pipe where the wire leaves the wire feeding pipe.

3. A wire feeding device comprising a wire feeding pipe, a feed unit that pushes a wire through the wire feeding pipe, wherein the wire feeding pipe has an attached, overlapping, or inserted extension segment extending beyond a distal end of the wire feeding pipe, the extension section having an inlet and an outlet for the wire, wherein the extension section comprises a two-way shape-memory alloy, and wherein the two-way shape-memory alloy has a trained shape in a martensite phase having a passageway for a wire and a trained shape in an austenite phase having a passageway for a wire that is narrower than the martensite phase passageway.

4. A wire feeding device according to claim 3, wherein the extension segment bridges between the wire feeding pipe and a welding torch.

5. A wire feeding device according to claim 3, wherein the feed unit comprises wire feeding wheels.

6. A joining process, comprising providing a wire used in joining two articles by: feeding wire through a wire feeding device according to claim 3; and heating the two-way shape-memory alloy above its martensite to austenite phase transition temperature and narrowing the passageway by applying pressure to straighten a bend in the wire that aids in positioning the wire in the joining process.

7. A joining process according to claim 6, wherein the joining process is selected from the group consisting of gas metal arc welding, laser welding, laser brazing, arc brazing, TIG welding, and wire-to-wire welding.

8. A joining process according to claim 6, wherein the wire is heated in the heating step.
